(19) United States
(12) Patent Application Publication
(10) Pub. No.: US 2013/0326352 A1
(43) Pub. Date: Dec. 5, 2013

(54) System For Creating And Viewing Augmented Video Experiences

(71) Applicant: Kyle Douglas Morton, Waltham, MA (US)

(72) Inventor: Kyle Douglas Morton, Waltham, MA (US)

(21) Appl. No.: 13/904,651

(22) Filed: May 29, 2013

Related U.S. Application Data
(60) Provisional application No. 61/653,202, filed on May 30, 2012.

(51) Int. Cl. G06F 3/0484

(52) U.S. Cl. CPC G06F 3/0484
USPC 715/719

(57) ABSTRACT

In one aspect, a method to enable users to provide commentary to a video includes providing to fee users a social context to enable the users to view, filter, create and share commentary to the video. At least one user is not an original producer or an editor of the video and fee commentary includes at least one of text comments, animated reactions or audiovisual narrations and responses.

### RELATED APPLICATIONS

This application claims priority to Provisional Application Ser. No. 61/653,202 filed on May 30, 2012 and titled “SYSTEM FOR CREATING AND VIEWING AUGMENTED VIDEO EXPERIENCES,” which Is incorporated herein by reference in its entirety.

### BACKGROUND

Video that is enhanced with commentary is useful and valuable to people, but difficult for the average person to create. Given the ease of creation and sharing of videos by average people, this represents an imbalance with regard to engaging video audiences.

The level of technical sophistication required to create and share commentary is too high for the average viewer, as is the lack of dynamic and social filtering capabilities required to make the commentary useful for a large group of users. On the web, average viewers who wish to add commentary in reaction to a moment or event in the video can typically only add a comment which is shown as a static, non-synchronized element below the video. Further, existing solutions are typically designed for a specific video delivery platform (DVD or YOUTUBE®, for example), thus preventing the commentary from being accessed in other delivery scenarios.

The popularity of commentary systems that produce copious, yet irrelevant, low quality comments, demonstrates the need for an improved system for creating and viewing video commentary.

### SUMMARY

The techniques described herein relate to video creation and viewing systems and more particularly, to a system for creating and viewing augmented video experiences enhanced with complimentary elements. Such complimentary elements, referred to generally as “commentary,” include text comments, animated reactions, and audiovisual narrations and responses.

In one aspect a method to enable users to provide commentary to a video includes providing to the users a social context to enable the users to view, filter, create and share commentary to the video. At least one user is not an original producer or an editor of the video and the commentary includes at least one of text comments, animated reactions or audiovisual narrations.

In another aspect, an apparatus includes electronic hardware circuitry to enable users to provide commentary to a video and is configured to provide to the users a social context to enable the users to view, filter, create and share commentary to the video. At least one user is not an original producer of the video and the commentary includes at least one of text comments, animated reactions or audiovisual narrations. The circuitry includes at least one of a processor, a memory, a programmable logic device or a logic gate.

In a farther aspect, an article includes a non-transitory computer-readable medium that stores computer-executable instructions to enable users to provide commentary to a video. The instructions cause a machine to provide to the users a social context to enable the users to view, filter, create and share commentary to the video. At least one user is not an original producer of the video and wherein the commentary includes at least one of text comments, animated reactions or audiovisual narrations.

One or more of the aspects above may include one or more of the following features. Providing to the users a social context to enable the users to view, filter, create and share commentary to the video may include loading user interface elements, identifying a requested video asset, identifying an accessing device and a system environment, selecting a first mechanism to access the requested video asset on the accessing device, identifying runtime commentary permission of preference filters, selecting commentary matching stored or runtime user permissions and preferences, loading video for playback using a second mechanism, loading the second mechanism to synchronize commentary to video playback and loading new commentary collected from the user using the user interface elements. Loading the user interface elements may include rendering a canvas that may include a video frame to enable a user to view the video, a commentary source selector to enable the user to select a source of the commentary to integrate into the video, a comment box to enable a user to provide new commentary and a comment field to render commentary. Loading the user interface elements may further include rendering a canvas that further includes a timeline indicator of the commentary and a privacy setting of the comment to enable a user to set the privacy setting. One or more of the aspects above may include authenticating a requesting user. Providing to the users a social context may include providing to the users a video commentary using a social network. Selecting commentary matching stored or runtime user permissions and preferences may include selecting based on one of a higher or lower ranking or preference for degree of social connection, positive or negative sentiment, higher or lower enjoyment, or relevance to areas of interest or level of specificity of me commentary.

### BRIEF DESCRIPTION OF THE DRAWINGS

FIG. 1 is a flow chart, showing steps associated with a workflow; and

FIG. 2 is an exemplary screenshot showing user interface elements on a video display.

FIG. 3 is a computer on which all or part of the process of FIG. 1 may be implemented.

### DETAILED DESCRIPTION

In one example, the techniques described herein provide a system that enables easy creation of useful commentary appearing with a video at a specified interval in time and optionally placed at a relevant position with respect to the video frame. The techniques described herein allow commentary to he added by a user who is not the original producer or editor of the video. The techniques described herein further provide a system to view and comment within the context of a relevant social network or community.

Further, the techniques described herein provide for the viewing user to choose the video commentary they wish to see by selecting content from other users they are connected to by a social network, or from users that share common interests.

As used herein, the term, “video commentary” is used to describe audio and visual elements that are synchronized in time and visual placement to a playing video. The term “personalize” is used to refer to the use of user-to-user relationships, such as those defined in social networks, and content source and type preferences to customize the augmented video experience.

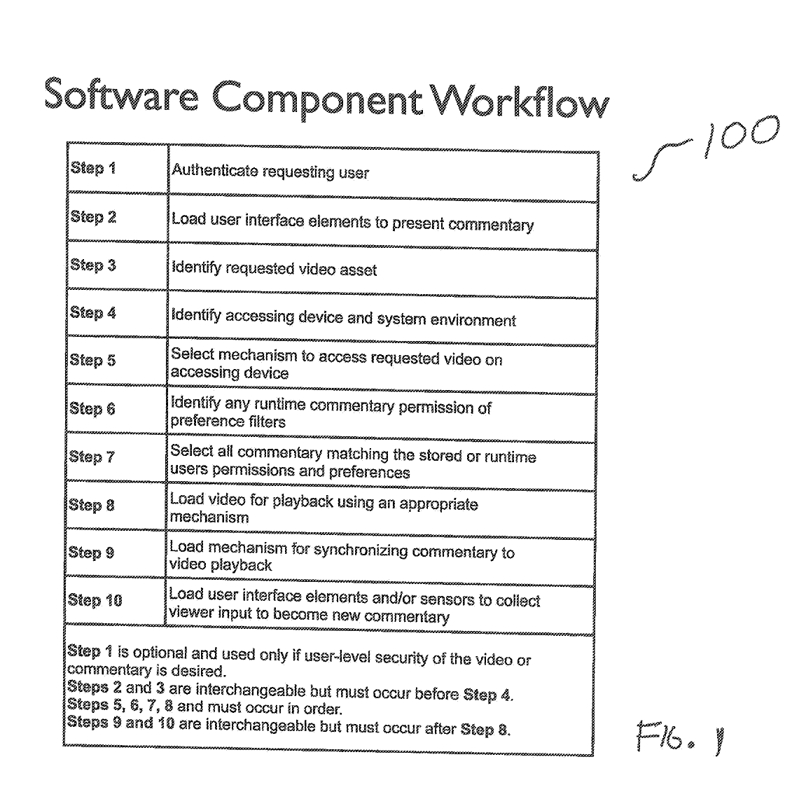

The techniques described herein include several sub-systems components working together to create the desired user experience. A description, of a typical usage scenario appears in the FIG. 1, “Software Component Workflow” (a process 100).

The video identification system can store and maintain metadata about all videos for which there is commentary. The metadata includes the video delivery platform of origin (e.g. YOUTUBE® or FACEBOOK®), which devices the video can be technically delivered on, pointers to the code or methods required to deliver the video, a unique identifier and a reference to a canonical identifier if the video is a version of another video.

The user system can store and maintain metadata about all creators of commentary. The metadata includes the system of origin which defined the user (e.g., YOUTUBE® or FACEBOOK®), user defined preferences for the commentary they wish to see, and pointers to the code or methods required to derive social network relationships between users.

The commentary system can store and maintain the commentary itself including text, images, media, instructions for synchronization and display. The commentary system can also store and maintain metadata describing and classifying the commentary, access and usage statistics, user ratings and security settings.

An internet-accessible application programming interface (API) can be used to insert and retrieve information from the various systems. The user interface leverages the API to request information and interpret the retrieved content and instructions. The user interface can contain various methods of synchronising the commentary to the video, depending on the type and method of playing the video on the accessing device. These methods include event listeners, which receive notifications from the video as it progresses on a timeline and triggers commentary matching the time, and methods that poll the video at sub-second intervals to request the current time position of playback to synchronize the commentary.

The user interface can also contain a process to interpret settings for commentary presentation and content and render it appropriately. The user interface should contain controls to allow a user to input commentary and define preferences for the type and content of commentary they wish to be presented with. The system can intelligently suggest filters based on connections with other users and prior interactions with content.

The user interface may contain one or more of the following elements for collecting input from the viewer for the purpose of selecting, creating, editing or sharing commentary: (1) a comment box to enter text commentary, (2) an interface to capture images, audio or video (3) an interface to draw on, and (4) a gesture interpreter to indicate a create, edit or share action.

The techniques described herein can he made using standard software components and software architecture techniques. First, one needs to construct the data structures needed to store and maintain the video, user and commentary metadata using a system such as the MySQL database.

Next, one needs to create a web API tor inserting and retrieving information from the databases. This can be done using any server-side programming such as PHP, Next, one needs to implement logic for selecting only the commentary a requesting user is allowed to see, or desires to see based on preferences stored in user and commentary metadata. Next, one needs to identify how to access and play a video of a certain type on a certain device. For example, most web video can be played in a desktop web browser with an embedded Flash object provided by the video platform provider such as YOUTUBE®. This method can be captured in code mat can be interpreted by the user interface so when a video of a certain type is requested, it can be played.

In the example of YOUTUBE®, one would next need to add event listeners to the time-updated JavaScript event triggered by the YOUTUBE® video player. In the listener code, one needs to check if mere is synchronized commentary to be shown.

Next one needs to implement a user interface for collecting commentary from the viewer. This can include an input box on the screen where a text comment can be entered. When text is being entered, the current time of the video can be recorded as metadata along with the entered text, who entered it and any other optional presentation or descriptive metadata. This content should then be posted to the API for storage.

Finally one needs to implement a user interface or other method of allowing a user to define their preferences for what commentary they wish to see and from whom.

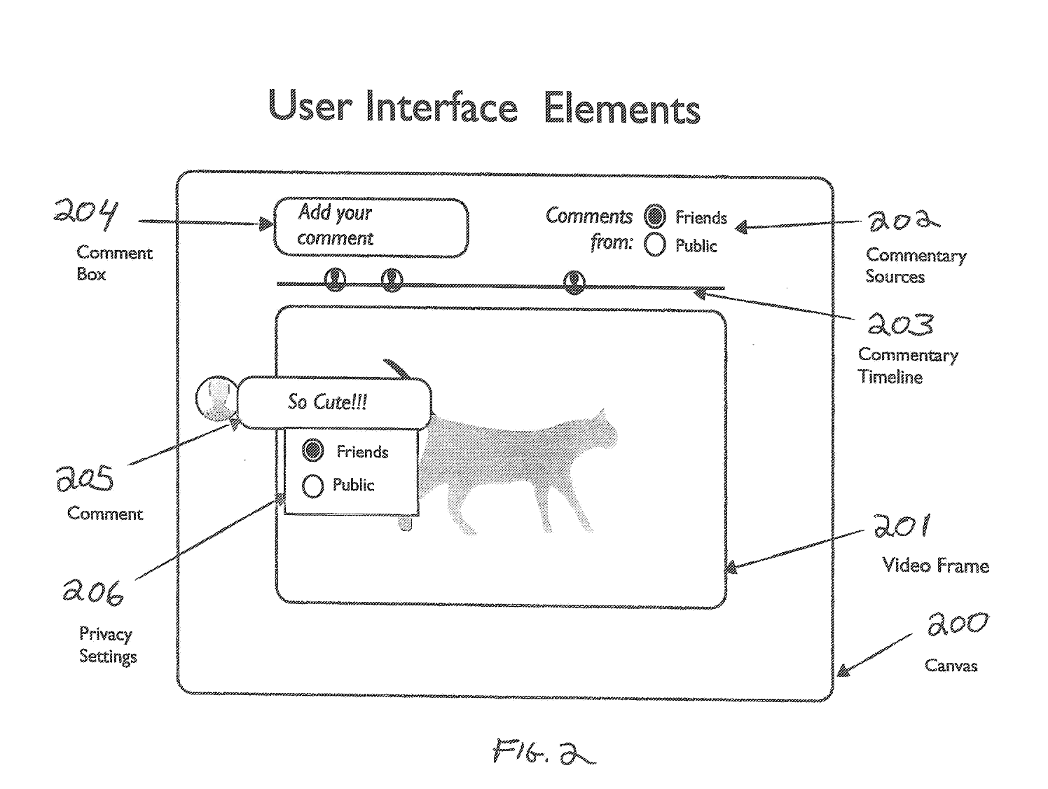

A wireframe diagram of the primary user interface is shown in FIG. 2, “User Interface Elements”. A user is presented with a software canvas for viewing and contributing to the commentary for a video 200. A user would first view a video 201 and choose the sources of commentary they would like to see integrated with it 202. During the video playback, they would see, hear or otherwise perceive commentary left by other users whom they may know 203. The user may provide their own commentary on the video in some form of input the system, would capture. Exemplary input may include typing text into a comment box 204 or drawing on top of the video. Next the user reaction is integrated into the video as a comment 205 and the privacy settings for sharing the commentary 206 can be specified. Finally, the software shares the enhanced video they created with other users.

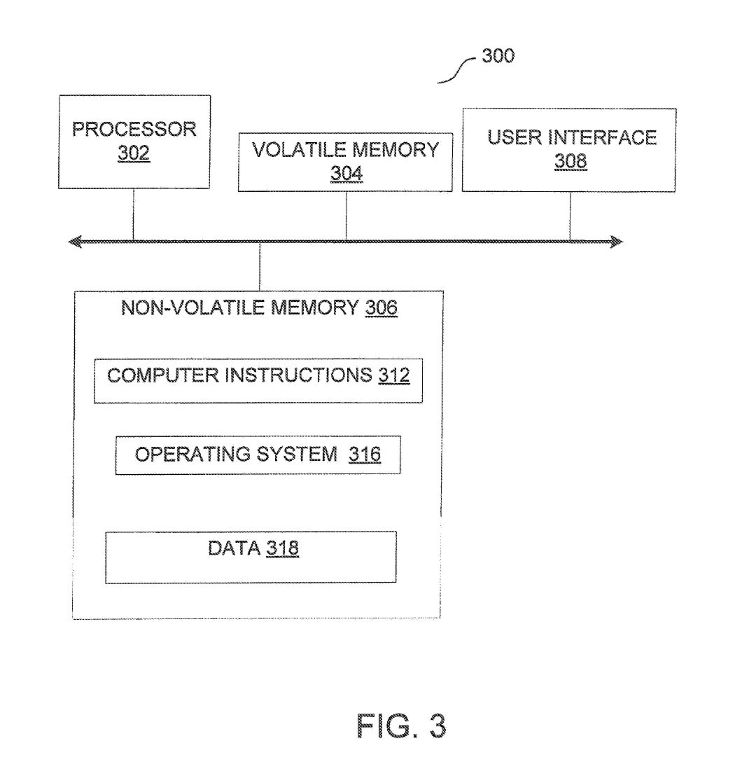

Referring to FIG. 3, in one example, a computer 300 includes a processor 302, a volatile memory 304, a non-volatile memory 306 (e.g., hard disk) and the user interface (UI) 305 (e.g., a graphical user interface, a mouse, a keyboard, a display, touch screen and so forth). The non-volatile memory 306 stores computer instructions 312, an operating system 316 and data 318. In one example, the computer instructions 312 are executed by the processor 302 out of volatile memory 304 to perform all or part of the processes described herein (e.g., process 100).

The processes described herein (e.g., process 100) are not limited to use with the hardware and software of FIG. 3; they may find applicability in any computing or processing environment and with any type of machine or set of machines that is capable of running a computer program. The processes described herein may be implemented in hardware, software, or a combination of the two. The processes described herein may be implemented in computer programs executed on programmable computers/machines that each includes a processor, a non-transitory machine-readable medium or other article of manufacture that is readable by foe processor (including volatile and non-volatile memory and/or storage elements), at least one input device, and one or more output devices. Program code may be applied to data entered using an input device to perform any of the processes described herein and to generate output information.

The system may be implemented, at least in part, via a computer program, product, (e.g., in a son-transitory machine-readable storage medium such as, for example, a non-transitory computer-readable medium), for execution by, or to control the operation of, data processing apparatus (e.g., a programmable processor, a computer, or multiple computers)). Each such program may be implemented in a high level procedural or object-oriented programming language to communicate with a computer system. However, the programs may he implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a non-transitory machine-readable medium that is readable by a general or special purpose programmable computer for configuring and operating the computer when the non-transitory machine-readable medium is read by the computer to perform the processes described herein. For example, the processes described herein may also be implemented as a non-transitory machine-readable storage medium, configured with a computer program, where upon execution, instructions in the computer program cause the computer to operate in accordance with the processes. A non-transitory machine-readable medium may include but is not limited to a hard drive, compact disc, flash memory, non-volatile memory, volatile memory, magnetic diskette and so forth but does not include a transitory signal per se.

In some embodiments, algorithms for suggesting which commentary is most likely to appeal to a specific user could be added to improve the user experience. Such algorithms may take into account a higher or lower ranking or preference for degree of social connection, positive or negative sentiment, higher or lower enjoyment relevance to areas of interest or level of specificity of the commentary. In some embodiments, periodic solicitation of user reactions is allowed and immediate delivery of commentary to live video streams to provide running commentary to a live audience is allowed. In some embodiments, games and contests for the creation of commentary could be included to provide additional incentives for the creation of augmented video. In some embodiments, algorithms that effectively integrate the comments from multiple contributors in a single viewing could be added to facilitate high-quality collaborative commentary.

Elements of different embodiments described herein may be combined to form other embodiments not specifically set forth above. Other embodiments not specifically described herein are also within the scope of the following claims.

What is claimed is:

1. A method to enable users to provide commentary to a video, the method comprising:
providing to the users a social context to enable the users to view, filter, create and share commentary to the video, the providing comprising:
loading user interface elements a video frame to enable a user to view the video, loading the user interlace elements comprising rendering a canvas comprising a video frame to enable a user to view the video, a commentary source selector to enable the user to select a source of the commentary to integrate into the video, a comment box to enable a user to provide new commentary and a comment field to render commentary;
identifying a requested video asset;
identifying an accessing device and a system environment;
selecting a first mechanism to access the requested video asset on the accessing device;
identifying runtime commentary permission of preference filters;
selecting commentary matching stored or runtime user permissions and preferences;
loading video for playback using a second mechanism;
loading the second mechanism to synchronize commentary to video playback; and
loading new commentary collected from the user using the user interface elements,
wherein at least one user is not an original producer of the video,
wherein the commentary comprises at least one of text comments, animated reactions or audiovisual narrations.

2. A method to enable users to provide commentary to a video, the method comprising:
providing to the users a social context to enable the users to view, filter, create and share commentary to the video,
wherein at least one user is not an original producer of the video,
wherein the commentary comprises at least one of text comments, animated reactions or audiovisual narrations.

3. The method of claim 2 wherein providing to the users comprises:
loading user interface elements;
identifying a requested video asset;
identifying an accessing device and a system environment;
selecting a first mechanism to access fee requested video asset on the accessing device;
identifying runtime commentary permission of preference filters;
selecting commentary matching stored or runtime user permissions and preferences;
loading video for playback using a second mechanism;
loading the second mechanism to synchronize commentary to video playback; and
loading new commentary collected from the user using the user interface elements.

4. The method of claim 3, wherein selecting commentary matching stored or runtime user permissions and preferences comprising selecting based on one of a higher or lower ranking or preference for degree of social connection, positive or negative sentiment, higher or lower enjoyment, or relevance to areas of interest or level of specificity of the commentary.

5. The method of claim 3 wherein loading the user interface elements comprises rendering a canvas comprising:
a video frame to enable a user to view the video;
a commentary source selector to enable the user to select a source of the commentary to integrate into the video;
a comment box to enable a user to provide new commentary; and
a comment field to render commentary.

6. The method of claim 5 wherein loading the user interface elements further comprises rendering a canvas further comprising:
a timeline indicator of the commentary; and
a privacy setting of the comment to enable a user to set the privacy setting.

7. The method of claim 3, further comprising authenticating a requesting user.

8. The method of claim 2 wherein providing to the users a social context-comprises providing to the users a video commentary using a social network.

9. An apparatus, comprising:
electronic hardware circuitry to enable users to provide commentary to a video and configured to:
provide to the users a social context to enable the users to view, filter, create and share commentary to the video,
wherein at least one user is not an original producer of the video,
wherein the commentary comprises at least one of text comments, animated reactions or audiovisual narrations and responses,
wherein the circuitry comprises at least, one of a processor, a memory, a programmable logic device or a logic gate.

10. The apparatus of claim 8 wherein the circuitry configured to provide to fee users a social context to enable the users to view, filter, create and share commentary to the video comprises circuitry configured to:
load user interface elements;
identify a requested video asset;
identify an accessing device and a system environment;
select a first mechanism to access the requested video asset on the accessing device;
identify runtime commentary permission of preference filters;
select commentary matching stored or runtime user permissions and preferences;
load video for playback using a second mechanism;
load the second mechanism to synchronize commentary to video playback; and
load new commentary collected from the user using the user interface elements.

11. The apparatus of claim 10 wherein the circuitry configured to load the user interface elements comprises circuitry configured to render a canvas comprising:
a video frame to enable a user to view the video;
a commentary source selector to enable the user to select a source of the commentary to integrate into the video;
a comment box to enable a user to provide new commentary; and
a comment field to render commentary.

12. The apparatus of claim 11 wherein the circuitry configured to load the user interface elements further comprises circuitry configured to render a canvas further comprising:
a timeline indicator of the commentary; and
a privacy setting of the comment to enable a user to set the privacy setting.

13. The apparatus of claim 10, further comprising circuitry configured to authenticate a requesting user.

14. The apparatus of claim 8 wherein the circuitry configured to provide to the users a social context comprises circuitry configured to provide to the users a video commentary using a social network.

15. An article comprising:
a non-transitory computer-readable medium that stores computer-executable instructions to enable users to provide commentary to a video, the instructions causing a machine to:
provide to the users a social context to enable the users to view, filter, create and share commentary to the video,
wherein at least one user is not an original producer of the video,
wherein the commentary comprises at least one of text comments, animated reactions or audiovisual narrations.

16. The article of claim 15 wherein the instructions causing a machine to provide to the users a social context to enable the users to view, filter, create and share commentary to the video comprises instructions causing a machine to:
load user interface elements;
identify a requested video asset;
identify an accessing device and a system environment;
select a first mechanism to access the requested video asset on the accessing device;
identify runtime commentary permission of preference filters;
select commentary matching stored or runtime user permissions and preferences;
load video for playback using a second mechanism;
load the second mechanism to synchronize commentary to video playback; and
load new commentary collected from the user using the user interface elements.

17. The article of claim 16 wherein the instructions causing a machine to load the user interface elements comprises instructions causing a machine to render a canvas comprising:
a video frame to enable a user to view the video;
a commentary source selector to enable the user to select a source of the commentary to integrate into the video;
a comment box to enable a user to provide new commentary; and
a comment field to render commentary.

18. The article of claim 17 wherein the instructions causing a machine to load the user interface elements further comprises instructions causing a machine to render a canvas further comprising:
a timeline indicator of the commentary; and
a privacy setting of the comment to enable a user to set the privacy setting.

19. The article of claim 16, further comprising instructions causing a machine to authenticate a requesting user.

20. The article of claim 15 wherein the instructions causing a machine to provide to the users a social context comprises instructions causing a machine to provide to the users a video commentary using a social network.
